(19) United States
(12) Patent Application Publication
(10) Pub. No.: US 2009/0167550 A1
(43) Pub. Date: Jul. 2, 2009

(54) DATA RESULT DETERMINATION METHODS AND SYSTEMS

(76) Inventors: Fu-Chiang CHOU, Taoyuan County (TW); Huei-Long Wang, Taoyuan County (TW); Wei-Ting Hsieh, Taoyuan County (TW)

Correspondence Address: BIRCH STEWART KOLASCH & BIRCH, PO BOX 747, FALLS CHURCH, VA, 22040-0747, US

(21) Appl. No.: 12/339,851

(22) Filed: Dec. 19, 2008

(30) Foreign Application Priority Data
Dec. 27, 2007 (TW) 96150501

(51) Int. Cl. G08B 21/00; G08B 7/00

(52) U.S. Cl. 340/686.1; 340/691.6; 702/141

(57) ABSTRACT

Data result determination methods and systems for use in an electronic device having a motion sensor are provided. First, at least one object is displayed in a display unit. Then, an action is detected by the motion sensor. The object displayed in the display unit is moved according to the action, and the object moving according to the action is displayed in the display unit. Finally, a data result is determined according to a state of the moved object.

### CROSS REFERENCE TO RELATED APPLICATIONS

This application claims priority of Taiwan Patent Application No. 096150501, filed on Dec. 27, 2007, the entirety of which is incorporated by reference herein.

### BACKGROUND OF THE INVENTION

1. Field of the Invention

The disclosure relates generally to data result determination methods and systems using a motion sensor, and, more particularly to methods and systems that use a motion sensor to detect a user's action, and determine a data result according to the user's action.

2. Description of the Related Art

Recently, portable devices, such as handheld devices, have become more and more technically advanced and multifunctional. For example, a handheld device may have e-mail message capabilities, an advanced address book management system, a media playback system, and various other functions. Due to increased convenience and functions of the devices, these devices have become necessities of life.

In some data applications, such as fortune-telling applications, users can input specific data, such as name and birth information, and the input data is calculated using a fixed formula to accordingly determine a specific result from a plurality of predefined results. For this data application, when the input data is the same, the result is always the same. For another data application, users do not need to input personal information, but directly select a specific result from predefined results via computing devices randomly.

### BRIEF SUMMARY OF THE INVENTION

Data result determination methods and systems using a motion sensor are provided. In the invention, users can participate in the determination procedure of data results. Data results can be determined according to a user's specific actions.

In an embodiment of a data result determination method for use in an electronic device having a motion sensor, at least one object is displayed in a display unit. Then, an action is detected by the motion sensor. The object displayed in the display unit is moved according to the action, and the object moving according to the action is displayed in the display unit. Finally, a data result is determined according to a state of the moved object.

An embodiment of a data result determination system includes a display unit a motion sensor, and a processing unit coupled to the motion sensor. The display unit displays at least one object. The motion sensor detects an action. The processing unit moves the object displayed in the display unit according to the action, and displays the moving object via the display unit. The processing unit determines a data result according to a state of the moved object.

Data result determination methods and systems may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a data result determination system using a motion sensor of the invention;

FIG. 2 is a flowchart of an embodiment of a data result determination method using a motion sensor of the invention;

FIG. 3A shows a picture of a data application;

FIG. 3B shows another picture, wherein the object in the picture of FIG. 3A has been moved; and

FIG. 4 shows further another picture, displaying a data result corresponding to the moved object in FIG. 3B.

### DETAILED DESCRIPTION OF THE INVENTION

Data result determination methods and systems using a motion sensor are provided.

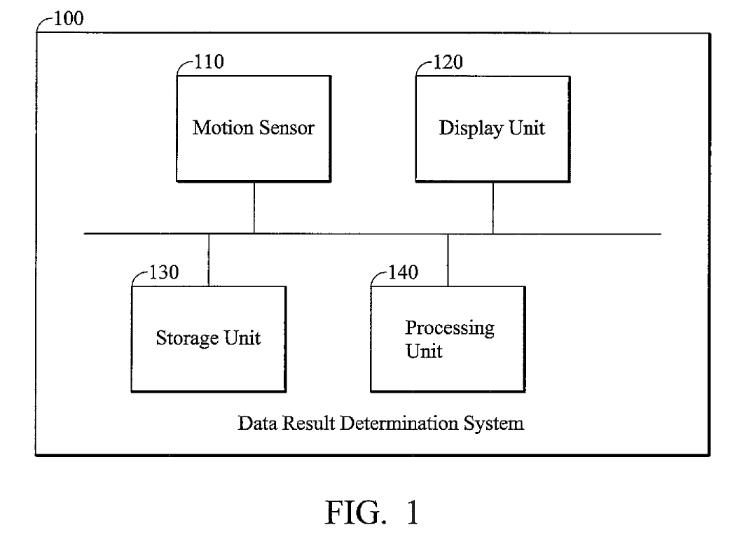

FIG. 1 is a schematic diagram illustrating an embodiment of a data result determination system using a motion sensor of the invention. The data result determination system can be used in an electronic device, such as a portable device comprising handheld devices such as a media player, a PDA (Personal Digital Assistant), a GPS (Global Positioning System) device, a smartphone, and a mobile phone.

The data result determination system 100 comprises a motion sensor 110, a display unit 120, a storage unit 130, and a processing unit 140. The motion sensor 110 can detect actions applied by users to the electronic device. The actions detected by the motion sensor 110 can comprise a direction and strength applied to the electronic device. In some embodiments, the motion sensor can comprise an acceleration sensor or a gravity sensor. The above sensors are examples of the invention, any motion sensor that can detect actions applied by users to the electronic device can be applied in the invention. The display unit 120 can display related operational interfaces and pictures of a data application, and related information. The storage unit 130 can store several data items (not shown), such as images, voice, and/or texts. Each data item can correspond to at least one object state. The processing unit 140 performs data result determination methods of the invention. Related details are discussed later.

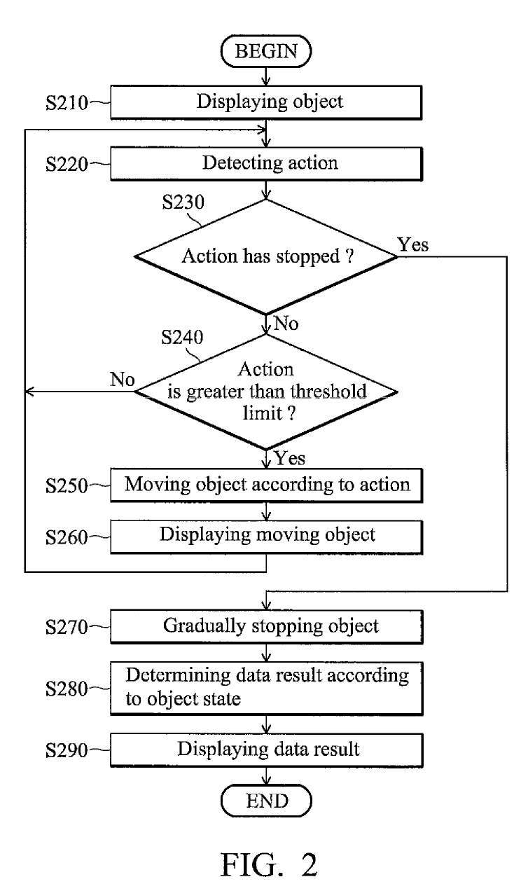

FIG. 2 is a flowchart of an embodiment of a data result determination method using a motion sensor of the invention.

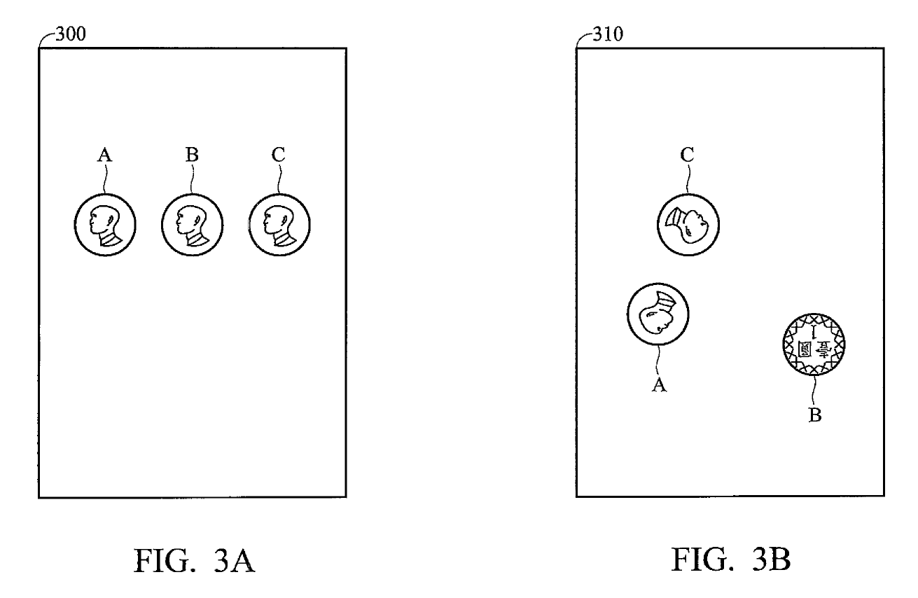

In step S210, at least one object is displayed in the display unit. In the application of fortune-telling, the object may be a lot in a lots container, a divining crescent, and/or a coin. The number of the objects can be adjusted based on different data applications. In some embodiments, the objects may include three coins (A, B and C), as shown in the picture 300 of FIG. 3A. In the example of FIG. 3A, the three coins (A, B and C) can be used to perform a data application, such as fortune-telling. Then, users can apply an action to the electronic device. In step S220, an action applied by the users to the electronic device is detected by the motion sensor. It is noted that, the action may comprise a direction and strength applied to the electronic device. In step S230, it is determined whether the action has stopped. If the action has not stopped (No in step S230), in step S240, it is determined whether the action is greater than a threshold limit, such as a bigger action. When the action is not greater than the threshold limit (No in step S240), the procedure returns to step S220. When the action is greater than the threshold limit (Yes in step S240), in step S250, the object is moved according to the action, and in step S260, the moving object is displayed in the display unit. That is, users can see the moving object in the display unit. Then, the procedure returns to step S220.

Since the action comprises the direction and strength applied to the electronic device, the object can be moved according to the direction of the action, and/or the object can be moved according to the strength applied to the electronic device and a physical mechanical property. In some embodiments, the time for moving the object can be extended based on the action. Additionally, a state, such as an arrangement, a direction, and/or a position of the object can be also affected based on the strength applied to the electronic device and the physical mechanical property. The object can accomplish physical effects, such as shifting, rotation and rolling based on the direction and the strength applied to the electronic device of the detected action and the physical mechanical property.

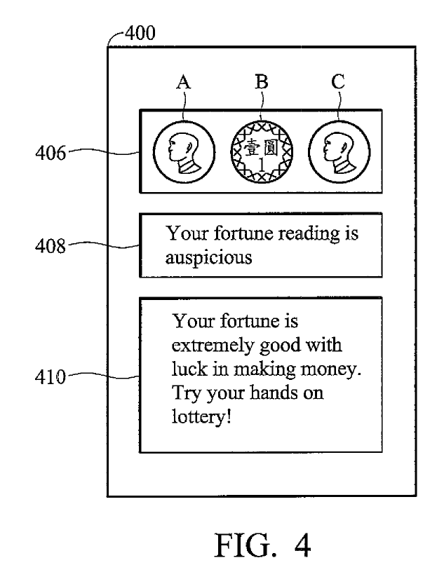

If the action stops (Yes in step S230), in step S270, the object is gradually stopped, and the moved object (after moving) is displayed in the display unit. In the above example of three coins, a picture 310 having three moved coins is shown in FIG. 3B. In step S280, a specific data result, such as an image, a voice, and/or texts is retrieved from the storage unit according to the state, such as the arrangement, the direction, and/or the position of the moved object, and in step S290, the retrieved data (data result) is displayed in the display unit. The data result corresponding to the moved coins in FIG. 3B is shown in FIG. 4. In FIG. 4, a picture 400 may comprise related descriptions and/or images for interpreting the state of the three coins. In the example of FIG. 4, the picture 400 comprises an object display area 406, a hexagram description area 408, and a fortune-telling area 410. The object display area 406 displays the moved object. The hexagram description area 408 describes the hexagram corresponding to the moved coins. The fortune-telling area 410 describes contents represented by the hexagram in the hexagram description area 408.

It is understood that, fortune-telling is only an example of a data application in the embodiments. The invention is not limited thereto, and any data application can be applied in the present invention. It is to be stated again, that users can participate in the determination procedure of data results, and the data results can be determined according to users' specific actions. Since all possible data results are known, the determination of data results can be considered as being “physically random generated”, wherein one of the data results can be determined based on the participation of users. Compared to the conventional data application where the same data result is obtained when the same data is input, the input procedure of data of the invention will also affect the determined data result. The input procedure is the users' action. Therefore, user satisfaction is enhanced due to the increase of user participation during the input procedure, and the variety of data results.

Data result determination methods and systems, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A data result determination method for use in an electronic device having a motion sensor, comprising:
displaying at least one object in a display unit;
detecting an action applied to the electronic device by the motion sensor;
moving the object displayed in the display unit according to the action, and displaying the moving object; and
determining a data result according to a state of the moved object.

2. The method of claim 1, wherein the motion sensor comprises an acceleration sensor or a gravity sensor.

3. The method of claim 1, further comprising gradually stopping the object when the action stops.

4. The method of claim 1, wherein the action comprises a direction, and the object is moved according to the direction.

5. The method of claim 1, wherein the action comprises strength applied to the electronic device, and the object is moved according to the strength and a physical mechanical property.

6. The method of claim 1, wherein the state comprises an arrangement, a direction, or a position of the object.

7. The method of claim 1, further comprising displaying the data result in the display unit.

8. The method of claim 1, wherein the data result comprises an image, a voice, or texts.

9. The method of claim 1, further comprising determining whether the action is greater than a threshold limit wherein the object is moved according to the action when the action is greater than the threshold limit.

10. A data result data result determination system for use in an electronic device, comprising:
a display unit displaying at least one object;
a motion sensor detecting an action applied to the electronic device; and
a processing unit coupled to the motion sensor, moving the object displayed in the display unit according to the action, displaying the moving object, and determining a data result according to a state of the moved object.

11. The system of claim 10, wherein the motion sensor comprises an acceleration sensor or a gravity sensor.

12. The system of claim 10, wherein the processing unit further gradually stops the object when the action stops.

13. The system of claim 10, wherein the action comprises a direction, and the processing unit moves the object according to the direction.

14. The system of claim 10, wherein the action comprises strength applied to the electronic device, and the processing unit moves the object according to the strength and a physical mechanical property.

15. The system of claim 10, wherein the state comprises an arrangement, a direction, or a position of the object.

16. The system of claim 10, wherein the processing unit further displays the data result in the display unit.

17. The system of claim 10, wherein the data result comprises an image, a voice, or texts.

18. The system of claim 10, wherein the processing unit further determines whether the action is greater than a threshold limit, and when the action is greater than the threshold limit, the processing unit moves the object according to the action.

19. A machine-readable storage medium comprising a computer program, which, when executed, causes a device having a motion sensor to perform a data result determination method, and the method comprising:
displaying at least one object in a display unit;
detecting an action applied to the device by the motion sensor;
moving the object displayed in the display unit according to the action, and displaying the moving object; and
determining a data result according to a state of the moved object.
